(19) United States
(12) Patent Application Publication
(10) Pub. No.: US 2007/0102662 A1
(43) Pub. Date: May 10, 2007

(54) Valve for single-use and multi-use applications

(75) Inventor: Thomas Allen Wills, Deland, FL (US)

Correspondence Address: PATTON BOGGS, 1660 LINCOLN ST, SUITE 2050, DENVER, CO, 80264, US

(73) Assignee: Gliders, Inc., Denver, CO (US)

(21) Appl. No.: 11/267,467

(22) Filed: Nov. 4, 2005

(51) Int. Cl. F16K 1/00

(52) U.S. Cl. 251/324

(57) ABSTRACT

The valve consists of a number of functional features, including: a housing, a piston, and a piston control mechanism configured to enable a user to operate the valve to enable flow of a product through the valve. The housing is shown as having a substantially streamlined shape, with the thickness of the housing being smaller than the length and width dimensions, thereby providing a major surface that enables a user to grasp the housing between the thumb and the index finger of the hand. The housing contains a channel formed therein extending from a first end of the housing to a second end of the housing forming a fluid conduit that enables passage of the product through the fluid conduit. The flow of product is regulated by a piston located in the channel and movable from a first position in the channel where the piston blocks the fluid conduit to a second position in the channel where the piston fails to block the fluid conduit. The piston is controlled by a control element, comprising either a slidable button or lever, which is connected to the piston and extends outside of the housing through an aperture to enable a user to operate the control element and thereby move the piston from the fluid conduit blocking position to a fluid conduit open position.

### FIELD OF THE INVENTION

This invention relates to valves for use in delivering liquid, semi-liquid, solid, and semi-solid products in various applications and, in particular, for single-use and multi-use applications.

### PROBLEM

It is a problem in the field of liquid, semi-liquid, solid, and semi-solid products to provide an economical applicator system for containing and dispensing a product in a safe, convenient, uniform, and simple manner on to a surface. The applicator system must be economical and simple to manufacture, especially when the applicator system is directed to the field of a single-use or a limited number of uses product application.

Many liquid, semi-liquid, solid, and semi-solid products can be applied to the desired surface by the user simply by placing the product on their hand from a container and then manually spreading the product on the desired surface. Examples of such products are personal care products such as sunscreen lotions, insect repellant, skin lotion, makeup, and the like; medical care products, such as topical lotions, medicated creams, and the like; sports products such as muscle heat ointments, eye black, anti-fogging coatings for lenses, and the like; and other products that can be abusive and irritating to the skin. The manual method of product application is the most inexpensive applicator system, but is also inefficient, messy, and may result in non-uniform application of the product to the desired surface. Contamination and microbiological concerns are significant when consumers handle topical products by hand. The product containers are also typically designed for multiple uses and, therefore, contain a fairly large quantity of the product, making the containers inconvenient to carry with the user. This quantity of product also may result in waste of the unused portion of the product. A further problem with this system is that the product is typically contained in a jar, tube, or bottle and is subject to spillage. For many of the products dispensed in this manner, it is undesirable to have a residue remain on the user's hands; the user, therefore, must have a mechanism available to clean their hands once the product has been applied to the desired surface.

To avoid the problems noted above, the liquid, semi-liquid, solid, and semi-solid products can be applied to the desired surface by the use of a separate applicator element, which the user must place in contact with the product. The applicator soaks up a quantity of the product from a product container, and the user then holds the product-containing applicator in their hand to spread the product on the desired surface. As noted above, the product containers are typically designed for multiple uses and, therefore, contain a fairly large quantity of the product, making the containers inconvenient to carry with the user. This quantity of product also may result in waste of the unused portion of the product.

One solution to the problems noted above is the use of single-use applicators, where the product is stored in a packet or reservoir and constitutes a sufficient amount for a single use. The cost of these disposable single-use applicators must be low to make them economical, so they typically rely on a burstable packet to release the stored product. A difficulty with burstable packet designs is that the mechanism used to rupture the packet is susceptible to operation at times other than desired by the inadvertent application of excessive force. In addition, the flow of the product through the rupture in the packet cannot be reliably controlled. The smaller heat seal used to direct product flow can rupture during elevated temperatures during transit, handling, or in a purse, pocket, car, or bag. Therefore, there is a need for a simple and inexpensive valve mechanism that can be used in single-use and multi-use applications, yet does not suffer from the disadvantages of existing burstable packet designs.

### SOLUTION

The above-described problems are solved and a technical advance achieved by the present valve for single-use and multi-use applications which functions with a minimal number of parts to provide a simple and reliable mechanism that presents a fluid conduit to control the flow of a product. The product in one implementation is stored in a packet or container and the valve is connected to the packet and functions to enable a user to reliably open a fluid conduit in the valve to connect the packet to an outlet in the housing that enables the user to apply the product to a surface. The valve is not susceptible to accidental operation and provides a fluid conduit of predetermined dimensions to control the flow of the product through the valve.

The valve consists of a minimal number of functional features implemented in a variable number of parts, which functional features include: a housing, a piston, and a piston control mechanism configured to enable a user to operate the valve to enable flow of a product through the valve. The housing is shown as having a substantially streamlined shape, with the thickness of the housing being smaller than the length and width dimensions, thereby providing a major surface that enables a user to grasp the housing between the thumb and one or more fingers of the hand. For example, the user would hold the product container (like the handle of a screwdriver) and use only the thumb to move the button and/or lever element to open and close the valve. The valve would be attached to the container via any of a number of methods: screw threads, adhesive, or any bonding method.

The housing contains at least one channel formed therein extending from a first end of the housing and from a second end of the housing to thereby form a flow controllable fluid conduit to enable passage of the product through the fluid conduit. The flow of product is regulated by a piston located in the channel and movable from a first position in the channel where the piston blocks the fluid conduit to a second position in the channel where the piston fails to block the fluid conduit. The piston is controlled by a control element, comprising either a slidable button or lever, which is connected to the piston and extends outside of the housing through an aperture to enable a user to operate the control element and thereby move the piston from the fluid conduit blocking position to a fluid conduit open position. In one embodiment, the valve is operable only in one direction, such that, once the valve is opened to allow the product to flow through the fluid conduit, the valve locks in place and cannot be closed by the reverse operation of the valve operation mechanism.

This valve thereby provides a low-cost element for product dispensing applications and can be manufactured with a minimal number of parts.

### BRIEF DESCRIPTION OF THE DRAWINGS

FIG. 1 illustrates a perspective view of one embodiment of the present valve for single-use applications;

FIGS. 2A-2C illustrate additional details of the housing in top cross-section, end cross-section, and side cross-section views, respectively;

FIGS. 3A and 3B illustrate a cross-section view of one embodiment of the valve which uses a button to operate the piston;

FIGS. 4A and 4B illustrate a cross-section view of one embodiment of the valve which uses a lever to operate the piston;

FIGS. 5A-5C illustrate first end, side, and second end cross-section views of the piston of FIGS. 3A, 3B, 4A, and 4B;

FIGS. 6A-6D illustrate additional details of the button in top cross-section, end cross-section, and side cross-section views, respectively; and

FIG. 7 illustrates a cross-section view of a second embodiment of the valve.

### DETAILED DESCRIPTION OF THE DRAWINGS

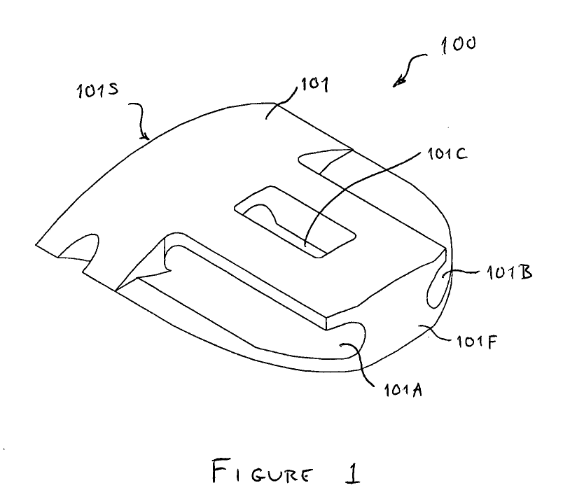

FIG. 1 illustrates a perspective view of one embodiment of the present valve 100 for single-use and multi-use applications, where the housing 101 is shown as having a substantially streamlined shape, with the thickness of the housing 101 being smaller than the length and width dimensions, thereby providing a major surface that enables a user to grasp the housing 101 between the thumb and the index finger of the hand. The valve 100 controls the flow of a product, and the housing 101 shown in FIG. 1 is affixed to a reservoir of product, such as a packet or container, that encloses a predetermined quantity of the product. The valve 100 illustrated in FIG. 1 is shown with a slidable button 103 as the control element, which is described in additional detail below. The slidable button 103 can be operated by the user to open a fluid conduit within the valve 100 that allows product to flow from the product reservoir through the valve 100, to be dispensed at an outlet of the valve.

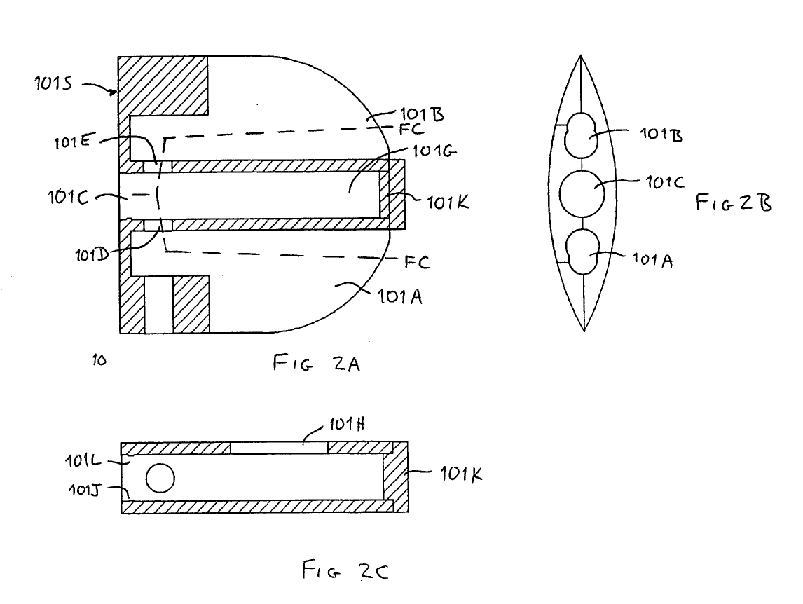

FIGS. 2A-2C illustrate additional details of the housing 101 in top cross-section, end cross-section, and side cross-section views, respectively. The housing 101 in this embodiment contains a fluid conduit (illustrated by dotted line FC) that extends from a first end 101F of the housing 101 to a second end 101S of the housing 101. The fluid conduit FC in this embodiment is implemented by using three coplanar channels formed in the body of the housing 101. A first 101A and a second 101B of these channels extend from a first end 101F of the housing 101, where they are open to the interior of the product reservoir and thence the product stored therein, to a location near the second end 101S of the housing 101. At this latter location, the first 101A and second 101B channels connect to a third, centrally located, channel 101C that provides the final extent of the fluid conduit FC to the outlet of the valve 100. Thus, as clearly seen in FIG. 2B, the three channels are coplanar, with the first 101A and second 101B channels being located one on either side of the third channel 101C. The third channel 101C is connected to the first 101A and second 101B channels via respective apertures 101D, 101E formed in the walls of the third channel 101C. The third channel 101C itself is formed in the body of the housing 101 and extends from the outlet on the second end 101S of the housing 101 to the first end 101F of the housing 101, with the extent of the third channel 101C being capable of optionally being terminated (such as by a plug 101K) without exiting the first end 101F of the body of the housing 101. The third channel 101C as shown in these Figures extends all the way through the body of the housing 101, although this is not a requirement. The section 101G of the third channel 101C that extends past the apertures 101D, 101E that interconnect the first 101A and second 101B channels to the third channel 101C is used to accommodate the sliding of the piston 102 that is installed in the third channel 101C to regulate the flow of product through the fluid conduit FC, as is described below. Therefore, the fluid conduit FC consists of the first 101A and second 101B channels, extending from the first end 101F of the body of the housing 101 to the apertures 101D, 101E where these two channels join the third channel 101C. The fluid conduit FC thence further extends through these apertures 101D, 101E and down the length of the third channel 101C to the valve outlet.

While this embodiment illustrates the use of two channels in parallel as the first segment of the fluid conduit, it is evident that a single channel can be used in place of the two channels shown herein. The exact configuration of the channels, apertures, piston, and control mechanisms shown herein are for illustration purposes, and it is expected that variations can be devised that perform the same function as the configuration disclosed herein.

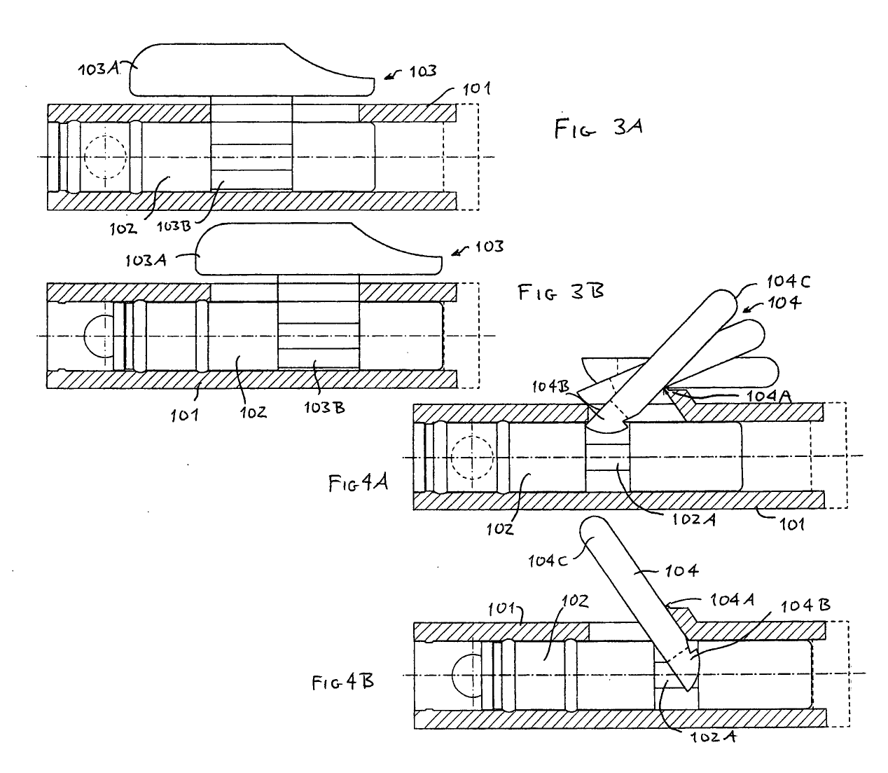

FIGS. 3A and 3B illustrate a cross-section view of one embodiment of the valve 100 of FIG. 1 which uses a button 103 to operate the piston 102. This valve 100 consists of a housing 101 that includes a third channel 101C formed therein through which the product flows. As described with respect to FIGS. 2A-2C, two apertures (first and second apertures) 101D, 101E are formed in the walls of the third channel 101C to enable a flow of product to exit the third channel 101C. A piston 102 is located in the third channel 101C and is slidable along the length of the third channel 101C to either block the first and second apertures 101D, 101E or to open a path from the third channel 101C to the apertures 101D, 101E. A third aperture 101H is formed in one wall of the third channel 101C to enable a control element, such as slidable button 103, to engage piston 102. The slidable button 103 can be transposed by a user from a first end of the third aperture 101H to a second end of the third aperture 101H to thereby relocate piston 102 from a first position shown in FIG. 3A, where piston 102 blocks first and second apertures 101D, 101E to a second position shown in FIG. 3B, where piston 102 is in a position to enable fluid communication from third channel 101C to first and second apertures 101D, 101E.

The shape and position of the longitudinal piston 102 is configured so that no crevice exists to accumulate fluid residue after partial use. This concept is critical in medical fluid applications and some adhesive products.

FIGS. 4A and 4B illustrate a cross-section view of one embodiment of the valve 100 of FIG. 1 which uses a lever 104 to operate the piston 102. This valve 100 consists of a housing 101 that includes a third channel 101C formed therein through which the product flows. As described with respect to FIGS. 2A-2C, two apertures (first and second apertures) 101D, 101E are formed in the walls of the third channel 101C to enable a flow of product to exit the third channel 101C. A piston 102 is located in the third channel 101C and is slidable along the length of the third channel 101C to either block the first and second apertures 101D, 101E or to open a path from the third channel 101C to the apertures 101D, 101E. A third aperture 101H is formed in one wall of the third channel 101C to enable a control element, such as hinged lever 104, to engage piston 102. The hinged lever 104 can be rotated by the user, causing the distal end of the hinged lever to transpose from a first end of the third aperture 101H to a second end of the third aperture 101H to thereby relocate piston 102 from a first position shown in FIG. 4A where piston 102 blocks first and second apertures 101D, 101E to a second position shown in FIG. 4B where piston 102 is in a position to enable fluid communication from third channel 101C to first and second apertures 101D, 101E. The hinged lever 104 consists of a hinge point 104A which attaches the hinged lever 104 to the housing 101 and around which the hinged lever 104 rotates. The engaging end 104B of the hinged lever 104 is shaped to fit into and engage the necked-down portion 102A of the piston 102. The curved face of the engaging end 104B enables the hinged lever 104 to slide the piston 102 laterally along the third channel 101C. The face of the hinged lever 104 opposite the curved face is flat, thereby preventing the engaging end 104B of the hinged lever 104 from slidably engaging the necked-down portion 102A of the piston 102. This prevents the hinged lever 104 from being used to return the piston 102 back to its original position, since the flat face of the engaging end 104B of the hinged lever 104 functions to lock the hinged lever 104 into an operating position.

The shape and position of the longitudinal piston 102 is configured so that no crevice exists to accumulate fluid residue after partial use. This concept is critical in medical fluid applications and some adhesive products.

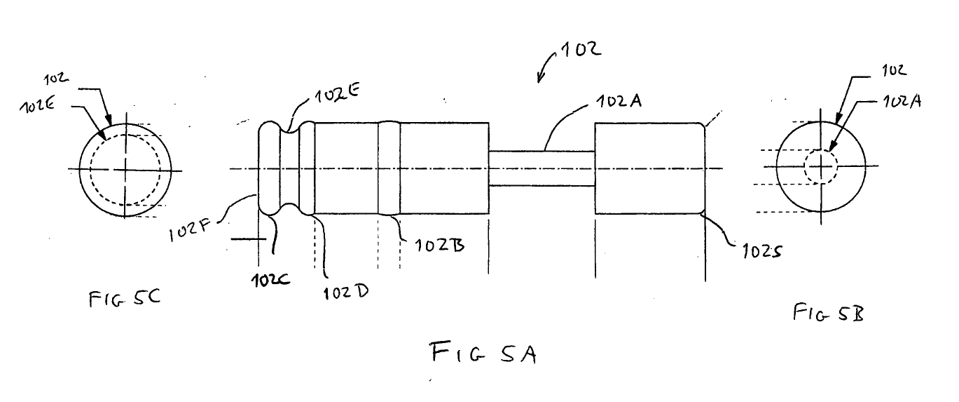

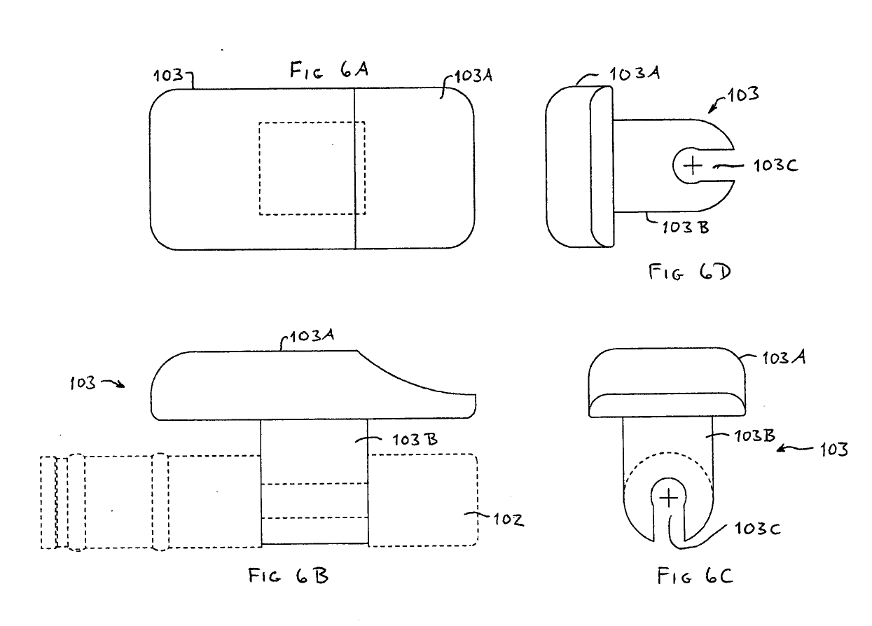

FIGS. 5A-5C illustrate first end, side, and second end cross-section views of the piston 102 of FIGS. 3A, 3B, 4A, and 4B. The piston 102 consists of a substantially cylindrical element that is shaped along its length with features to provide a valve closing/opening function as described below. In particular, a necked down portion 102A of the piston 102 is provided near a second end 102S of the piston 102 to accommodate connection to the control element 103/104 as shown in FIGS. 3A, 3B, 4A, and 4B. This enables the control element 103/104 to engage the piston 102 and apply a lateral force thereto to slide the piston 102 along the third channel 101C from the closed position of FIGS. 3A, 4A to the open position of FIGS. 3B, 4B. In addition, a shoulder 102B is formed in the piston 102 to thereby provide a sealing element to deter flow of the product from the fluid conduit FC down the third channel 101C along the length of the piston 102. The first end 102F of the piston 102 is shaped with two shoulder features 102C, 102D separated by a depression 102E, which serves to seal the fluid conduit FC at the second end 101S by engaging with the mating feature 101L and allow for smooth movement of the piston 102 along the third channel 101C as it is operated.

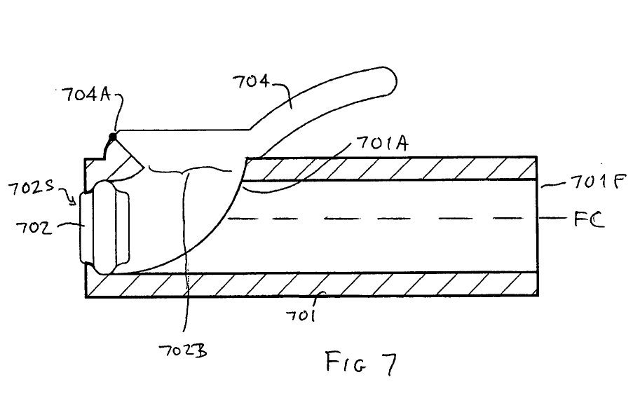

FIGS. 6A-6D illustrate additional details of the button 103 in top cross-section, end cross-section, and side cross-section views, respectively. The button 103 consists of a planar surface 103A to which is attached an operating element 103B that connects to the necked-down 102A portion of the piston 102. The button 103 clips onto the shaft (necked-down portion 102A) of the piston 102 via shaped opening 103C in the operating element 103B. The planar surface 103A is a low profile shape to minimize the size of the valve 100, yet provide an adequate point of contact for the user to enable simple operation of the valve 100 via a sliding movement.

FIG. 7 illustrates a cross-section view of a second embodiment of the valve 100. This embodiment uses a housing 701 with a single channel 701A formed therein, extending from a first end 701F of the body of the housing 701 to a second end 701S of the body of the housing 701. An aperture 702B is formed in the wall of the channel 701A to accept a piston (sealing element) 702. The piston 702 is located in the channel 701A at the second end thereof to block the flow of the product through the fluid conduit FC that is formed by the channel 701A. The piston operating mechanism consists of a lever 704, which is connected to the body of the housing 701 by a living hinge mechanism 704A and attached to the piston 702. When the lever 704 is pulled upward away from the body of the housing 701, it pulls the piston 702 into the aperture 702B, thereby unblocking the channel 701A and allowing the product to flow through the fluid conduit FC to the outlet of the valve 100. The piston part 702 (or sealing element) of the one-part valve can be positioned anywhere along the length of the lever 704, from the living hinge mechanism 704A to the end of the lever 704B. If the piston part 702 is positioned at the hinge end 704A, the user has great leverage and the lever movement is much greater. If the piston part 702 is located at the opposite end of the lever 704, the user has less leverage and the movement is much less.

### SUMMARY

The valve consists of a housing, a piston, and a piston control mechanism configured to enable a user to operate the valve to enable flow of a product through the valve. The housing is shown as having a substantially streamlined shape, with the thickness of the housing being smaller than the length and width dimensions, thereby providing a major surface that enables a user to grasp the housing between the thumb and the index finger of the hand. The housing contains a channel formed therein extending from a first end of the housing to a second end of the housing forming a fluid conduit that enables passage of the product through the fluid conduit. The flow of product is regulated by a piston located in the channel and movable from a first position in the channel where the piston blocks the fluid conduit to a second position in the channel where the piston fails to block the fluid conduit. The piston is controlled by a control element, comprising either a slidable button or lever, which is connected to the piston and extends outside of the housing through an aperture to enable a user to operate the control element and thereby move the piston from the fluid conduit blocking position to a fluid conduit open position.

What is claimed:

1. A valve for controlling the flow of a product that is in a one of a liquid, semi-liquid, solid, and semi-solid state comprising:
housing means having a channel formed therein extending from a first end of said housing means to a second end of said housing means forming a fluid conduit that enables passage of said product through said fluid conduit;
piston means located in said channel and movable from a first position in said channel where said piston means blocks said fluid conduit to a second position in said channel where said piston means fails to block said fluid conduit; and
piston control means for moving said piston means from said first position to said second position.

2. The valve of claim 1 wherein said piston means comprises:
channel-shaped means having exterior dimensions in a first plane to conform to an interior surface of said channel for blocking said fluid conduit and having an extent in an axis orthogonal to said first plane less than a length of said channel to enable said piston means to be movable from said first position in said channel to said second position in said channel.

3. The valve of claim 2 wherein said piston means further comprises:
control surface means formed in said channel-shaped means for receiving a mating element of said piston control means to enable engagement of said piston control means with said piston means.

4. The valve of claim 3 wherein said piston control means comprises:
button means having a major surface located external to said housing means for engagement by a user; and
control link means connected to said button means for engaging said control surface means to enable engagement of said piston control means with said piston means.

5. The valve of claim 4 wherein said housing means comprises:
control aperture means formed in an exterior surface of said housing means for enabling said control link means to extend through said control aperture means to engage said control surface means to enable engagement of said piston control means with said piston means.

6. The valve of claim 3 wherein said piston control means comprises:
lever means having a first end located external to said housing means for engagement by a user; and
control surface means formed on a second end of said lever means distal from said first end for engaging said control surface means to enable engagement of said piston control means with said piston means.

7. The valve of claim 6 wherein said housing means comprises:
control aperture means formed in an exterior surface of said housing means for enabling said second end of said lever means to extend through said control aperture means to enable said control surface means to engage said control surface means to enable engagement of said piston control means with said piston means.

8. The valve of claim 1 wherein said channel comprises:
first and second channel segment means extending in a parallel relationship from a first end of said housing means to a point juxtaposed to said second end of said housing means;
third channel segment means extending in a parallel relationship with said first and second channel segment means from a second end of said housing means toward said first end of said housing means; and
first and second apertures formed in walls of said third channel segment means to join said third channel segment means with said first and second channel segment means, respectively.

9. The valve of claim 8 wherein said first, second, and third channel segment means are oriented coplanar with said first channel segment means being located on one side of said third channel segment means and said second channel segment means being located on an opposite side of said third channel segment means.

10. The valve of claim 8 wherein said piston means comprises:
channel-shaped means having exterior dimensions in a first plane to conform to an interior surface of said channel for blocking said first and second apertures and having an extent in an axis orthogonal to said first plane less than a length of said channel to enable said piston means to be movable from said first position in said channel to said second position in said channel.

11. The valve of claim 1 wherein said channel comprises:
at least one channel segment means extending from a first end of said housing means to a point juxtaposed to said second end of said housing means;
outlet channel segment means extending in a parallel relationship with said at least one channel segment means from a second end of said housing means toward said first end of said housing means; and
at least one aperture formed in walls of said outlet channel segment means to join said outlet channel segment means with said at least one channel segment means.

12. The valve of claim 11 wherein said piston means comprises:
channel-shaped means having exterior dimensions in a first plane to conform to an interior surface of said outlet channel for blocking said at least one aperture and having an extent in an axis orthogonal to said first plane less than a length of said channel to enable said piston means to be movable from said first position in said channel to said second position in said channel.

13. The valve of claim 1 wherein said piston means comprises:
channel-shaped means having exterior dimensions in a first plane to conform to an interior surface of said channel for blocking said fluid conduit; and
wherein said housing means includes control aperture means formed in an exterior surface of said housing means for enabling said channel-shaped means to be moved through said control aperture means to a position where said piston means fails to block said fluid conduit.

14. The valve of claim 13 wherein said piston control means comprises:
lever means having a first end located external to said housing means for engagement by a user; and
control surface means formed on a second end of said lever means distal from said first end for engaging said piston means.

15. A valve for controlling the flow of a product that is in a one of a liquid, semi-liquid, solid, and semi-solid state comprising:
housing means having a first channel formed therein extending from a first end of said housing means and having at least one aperture formed in and extending through at least one side of said first channel to at least one additional channel that opens through a second end of said housing forming a fluid conduit from said first end of said housing means to said second end of said housing means through said first and said at least one additional channels to enable passage of said product through said fluid conduit;
piston means located in said first channel and movable from a first position in said first channel where said piston means blocks said fluid conduit to a second position in said channel where said piston means fails to block said fluid conduit; and
piston control means for moving said piston means from said first position to said second position.

16. The valve of claim 15 wherein said piston means comprises:
channel-shaped means having exterior dimensions in a first plane to conform to an interior surface of said first channel for blocking said at least one aperture and having an extent in an axis orthogonal to said first plane less than a length of said channel to enable said piston means to be movable from said first position in said channel to said second position in said first channel.

17. The valve of claim 16 wherein said piston means further comprises:
control surface means formed in said channel-shaped means for receiving a mating element of said piston control means to enable engagement of said piston control means with said piston means.

18. The valve of claim 17 wherein said piston control means comprises:
button means having a major surface located external to said housing means for engagement by a user; and
control link means connected to said button means for engaging said control surface means to enable engagement of said piston control means with said piston means.

19. The valve of claim 18 wherein said housing means comprises:
control aperture means formed in an exterior surface of said housing means for enabling said control link means to extend through said control aperture means to engage said control surface means to enable engagement of said piston control means with said piston means.

20. The valve of claim 17 wherein said piston control means comprises:
lever means having a first end located external to said housing means for engagement by a user; and
control surface means formed on a second end of said lever means distal from said first end for engaging said control surface means to enable engagement of said piston control means with said piston means.

21. The valve of claim 20 wherein said housing means comprises:
control aperture means formed in an exterior surface of said housing means for enabling said second end of said lever means to extend through said control aperture means to enable said control surface means to engage said control surface means to enable engagement of said piston control means with said piston means.

22. The valve of claim 15 wherein said at least one additional channel comprises:
first and second channel segment means extending in a parallel relationship from a second end of said housing means to a point juxtaposed to said first end of said housing means; and
wherein said at least one aperture comprises first and second apertures formed in walls of said first channel to join said first channel with said first and second channel segment means, respectively.

23. The valve of claim 22 wherein said piston means comprises:
channel-shaped means having exterior dimensions in a first plane to conform to an interior surface of said first channel for blocking said first and second apertures and having an extent in an axis orthogonal to said first plane less than a length of said first channel to enable said piston means to be movable from said first position in said first channel to said second position in said first channel.

24. The valve of claim 15 wherein said at least one additional channel comprises:
at least one channel segment means extending from a second end of said housing means to a point juxtaposed to said first end of said housing means;
outlet channel segment means extending in a parallel relationship with said at least one channel segment means from a first end of said housing means toward said second end of said housing means; and
at least one aperture formed in walls of said outlet channel segment means to join said outlet channel segment means with said at least one channel segment means.

25. The valve of claim 24 wherein said piston means comprises:
channel-shaped means having exterior dimensions in a first plane to conform to an interior surface of said first channel for blocking said first and second apertures and having an extent in an axis orthogonal to said first plane less than a length of said first channel to enable said piston means to be movable from said first position in said first channel to said second position in said first channel.

26. The valve of claim 15 wherein said piston means comprises:
channel-shaped means having exterior dimensions in a first plane to conform to an interior surface of said first channel for blocking said fluid conduit; and
wherein said housing means includes control aperture means formed in an exterior surface of said housing means for enabling said channel-shaped means to be moved through said control aperture means to a position where said piston means fails to block said fluid conduit.

27. The valve of claim 26 wherein said piston control means comprises:
lever means having a first end located external to said housing means for engagement by a user; and
control surface means formed on a second end of said lever means distal from said first end for engaging said piston means.
